(19) United States
(12) Patent Application Publication
(10) Pub. No.: US 2017/0214231 A1
(43) Pub. Date: Jul. 27, 2017

(54) INTEGRATED WIRING SYSTEM AND METHOD FOR MAKING AND USING THE SAME

(71) Applicant: Shenzhen Wiring Matrix Technologies Co., Ltd., Shenzhen (CN)

(72) Inventors: Daming Peng, Shenzhen (CN); Hailei Zhang, Sammamish, WA (US); Ya Guo, Chengdu (CN); Xintong She, Shenzhen (US)

(21) Appl. No.: 15/415,881

(22) Filed: Jan. 26, 2017

(30) Foreign Application Priority Data
Jan. 26, 2016 (CN) 2016100509256
Jan. 26, 2016 (CN) 2016100509580
Jan. 26, 2016 (CN) 2016200744232
Jan. 26, 2016 (CN) 2016200744656

(51) Int. Cl. H02G 3/00; G02B 6/44; H02G 3/04

(52) U.S. Cl. CPC H02G 3/263; H02G 3/0437; H02G 3/0406; G02B 6/4466

(57) ABSTRACT

A wiring system comprising a module-bearing platform and a plurality of function modules is disclosed. The system comprises a strong current wire tunnel, a weak current wire tunnel, and a wire duct. The strong current wire tunnel contains a strong current conductive wire linking power mains; the weak current wire tunnel contains a weak current conductive wire and a network cable connected to a background server. A method is also disclosed that integrates accessing mains power, providing weak current electric power source, and conducting data communication within a single wired system. The system and the method eliminate signal instability present in wireless communications of smart home settings and provide enhanced safety, compatibility and a flexible wire structure for easy and unrestricted accommodation of function modules according to the needs of users.

### CROSS-REFERENCE TO RELATED APPLICATION

This application claims priority to Chinese Patent Application No. CN2016100509256, filed on Jan. 26, 2016, titled “Integrated Link Device,” Chinese Patent Application No. CN2016100509580, filed on Jan. 26, 2016, titled “A Line-Carried Information and Physical System,” Chinese Utility Model Patent Application No, CN2016200744232, filed on Jan. 26, 2016, titled “Integrated Link Device,” and Chinese Patent Utility Model Application No. CN 2016200744656, filed on Jan. 26, 2016, titled “A Line-Carried Information and Physical System,” which are hereby incorporated by reference in its entirety.

### FIELD

This application relates in general to wiring systems for carrying electric energy and transmitting data and signals in human dwellings, in particular, to an integrated wiring system that facilitates intelligent management of smart homes and smart offices, and can be extended to all human habitations, including but not limit to, living space, working space, and any place where wired transmission of power, signal and data are applicable.

### BACKGROUND

Smart home is a living environment, wherein a residential area is a platform upon which a host of technologies, including wiring technology, network communication technology, security technology, automatic control technology, and audio and video technology are integrated to exercise centralized control and regulation on related devices and facilities, with an aim to improve safety, convenience, comfort, artistic ambiance, environmental protection, and energy conservation.

For successful implementation of a technology, the superiority of the technology itself is indispensable; in addition, another indispensable element is a structure for executing the technology that enables communication and transmission of signals and energies. Currently, smart homes depend almost entirely on wireless communication networks for data transmission, the popular ones including Zigbee, Z_Wave wireless communication technology, WIFI wireless communication technology, etc. One advantage for using wireless communication technologies is the absence of the burden of massive wires in a wired system, however, the trade-ins are several: low stability emanating from easy loss of data; difficulty in safeguarding privacy; and a lack of unified standard for smart home platforms. Thus a large number of terminal devices and equipment employed in day-to-day life cannot be intelligently integrated on a single platform, as a result compatibility is limited to power switches. Also, overall scalability is poor, and products are difficult to expand or scale up. Furthermore, eschewing challenges posed by wiring load is a common phenomenon in the industry. The accumulated outcome from all these conditions is a lack of products that meet user's needs.

Therefore, a need remains for a system and a method to reliably distribute energy, data, and signals in a human dwelling without a massive, messy and cumbersome burden of wirings, while still maintaining high levels of stability, safety, and scalability for the system, which are necessary to meet the need for smart homes, smart offices, etc. and to improve the efficiency for conventional home and buildings.

### SUMMARY

The invention aims to overcome the deficiencies and shortcomings of prior art and to provide a wiring structure that does away with common limitations that hinders the construction industry: limitation on the space of equipment placement; limitation on the quantity of the equipment placement; limitation on sequence of equipment placement; limitation on the controlled functional range of the equipment; and limitation on space separation between operating equipment. As a result, the invention ushers in the next generation product lines for the residential wiring industry, redefines smart home business in another level, and can be expanded to the entire human habitation. The device includes a plurality of function modules attached to a module-bearing platform. The plurality of function modules is connected, by wire, to weak current electric power and to network cable. The system enhances the safety of smart home control system, expand its functional range and is associated with strong stability. The module-bearing platform has strong compatibility and scalability for various function modules, thus allowing a user to add or remove function modules based on needs.

Consistent with above advantages, an integrated wiring system is disclosed. The system includes: a module-bearing, platform and a plurality of function modules removably secured to the platform; a wire pathway formed or enclosed between the platform and the plurality of the function modules, the wire pathway further divided into a strong current wire tunnel and a weak current wire tunnel; a strong current conductive wire, housed within the strong current wire tunnel, and operable to conduct strong current from an external power source such as power mains, distribution mains, or a power line; a weak current conductive wire, at least partially housed with the weak current wire tunnel, and operable to conduct weak current to the plurality of the function modules; a network cable, housed at least partially in the weak current wire tunnel and connected to a background server; one or more of the function modules connected to the strong current conductive wire.

In one embodiment, of the current invention, the number and the function of the function modules attached on the module-bearing platform can be increased or decreased based on user's needs.

In one embodiment of the current invention, the wire pathway enclosed between the platform and the function modules further comprises a wire duct that houses at least a portion the weak current conductive wire or at least a portion of the network cable.

In one embodiment of the current invention, one or more of the function modules are connected to the weak current connective wire or the network cable.

In one embodiment of the current invention, the module-bearing platform is a U-shaped module-bearing platform.

In one embodiment of the current invention, the U-shaped module-bearing platform is made of metal or metal alloy.

In one embodiment of the current invention, the U-shaped module-bearing platform and a plurality of the function modules enclose a wire pathway that is further partitioned via metal plates into the strong current wire tunnel, the weak current wire tunnel and the wire duct.

In one embodiment of the current invention, the weak current wire tunnel is placed between the strong current wire tunnel and the wire duct; the strong current wire tunnel comprises a neutral wire, a hot wire, and a ground wire, and the neutral wire, the hot wire, and ground wire are placed on the interior wall of the strong current wire tunnel; the weak current wire tunnel comprises two weak current conductive wires and two industry buses, and the two weak current conductive wires and the two industry buses are attached to the interior wall of the weak current wire tunnel.

In one embodiment of the current invention, the weak current conductive wire travels through the wire duct.

In one embodiment of the current invention, each attached function modules has a metal layer on the surface facing the platform.

In one embodiment of the present invention, the plurality of function modules is attached to the module-bearing platform through physical embedding, riveting, screwing, clasping, or adhesion.

In one embodiment of the present invention, the network cable includes at one from the group of Ethernet cable and fiber optic cable.

The present invention is advantageous in many aspects, The wires solve the problems of instability and narrow range of functional control present in the wireless communications in smart home/smart office design and implementations, by detachably attaching a plurality of smart home/smart office function modules unto a module-bearing platform, and connecting the plurality of the function modules to weak current lines and the network cables through wires. Smart home systems implementing the current invention will enjoy strong safety, wide compatibility, and a wide functional range for the controlled equipment. Easy expandability is also achieved by adding or subtracting function modules based on user's needs.

Still other embodiments will become readily apparent to those skilled in the art from the following detailed description, wherein embodiments are described by way of illustrating the best mode contemplated. As will be realized, other and different embodiments are possible and the embodiments' several details are capable of modifications in various obvious respects, all without departing from their spirit and the scope. Accordingly, the drawings and detailed description are to be regarded as illustrative in nature and not as restrictive.

### BRIEF DESCRIPTION OF THE DRAWINGS

FIG. 1 is prospective view showing an integrated wiring system 10 for providing strong current electric power, weak current electric power, and wired communication conduit, in accordance with one embodiment.

FIG. 2 is a cross section view of the integrated wiring system 10 as show in FIG. 1, in accordance with one embodiment.

FIG. 3 is a cross section view of a function module in accordance with one embodiment.

FIG. 4 is a cross section view of a function module in accordance with one embodiment.

FIG. 5 is a cross section view of a function module in accordance with one embodiment.

FIG. 6 is a cross section view of a function module in accordance with one embodiment.

FIG. 7 is a cross section view of a function module in accordance with one embodiment.

### DETAILED DESCRIPTION

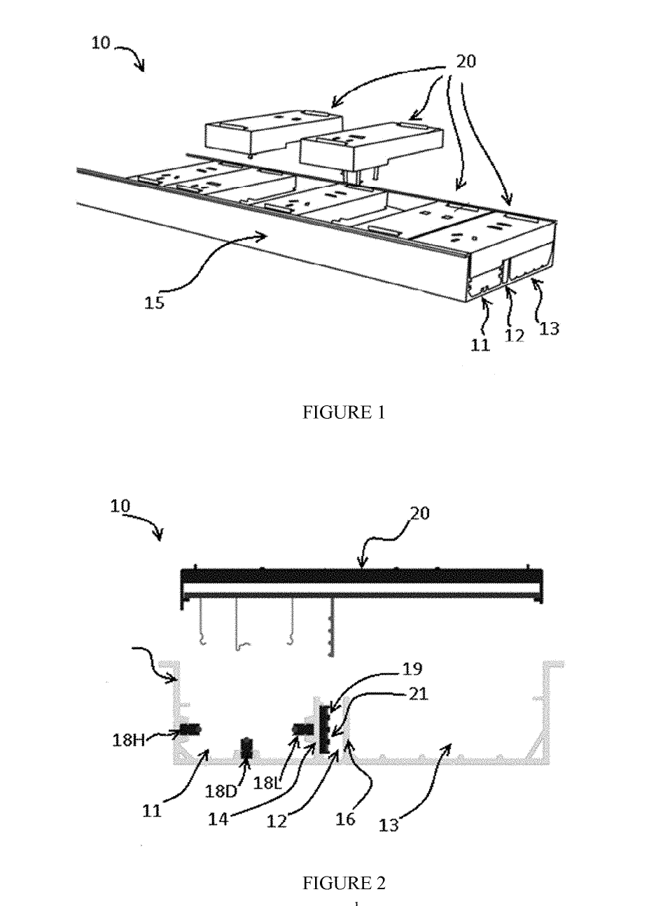

n integrated wiring system 10 is disclosed that facilitates designing and implementation of smart homes and smart offices, and can be useful in other human habitations. As shown in FIGS. 1 and 2, the integrated wiring system 10 provides a module-bearing platform 15 and, a plurality of function modules 20 that are detachably or removably, attached or secured to the platform 15. The plurality of the function modules 20 and the platform 15 enclose a tunnel-shaped wire pathway that is further partitioned into a strong current wire tunnel 11 and a weak current wire tunnel 12. The strong current wire tunnel 11 contains a strong current conductive wire that is configured to be connected to an external power source such as power mains, distribution mains, or a power line; the weak current wire tunnel 12 contains a weak current conductive wire 19 and a network cable 21 that is configured to be connected to a background server.

In one embodiment, the module-bearing platform 15 is made from metal or alloy material; alternatively, a metal or alloy layer is placed on the interior wall of the module-bearing platform. Furthermore, a strong current/weak current partition 14 is provided that is made of or contains a metal plate. As a result, electromagnetic interferences between the strong current wire tunnel 11 and the weak current wire tunnel 12 is minimized and the module-bearing platform strongly shields away electro-magnetic waves that cause signal interferences. In some circumstances the wiring system accommodates a large number of weak current conductive wires 19 that may cause interferes to each other and to the network cable 21. To curtail the problem, in one embodiment, a wire duct 13 is partitioned out from the strong current wire tunnel 11 and the weak current wire tunnel 12, by the introduction of a metal partition 16. At least a portion of the weak current conductive wires 19, as well as at least a portion of the network cables 21, can travel through the wire duct 13, ensuring enhanced safety and low-interference for the system.

The module-bearing platform 15 is an elongated platform that can be mounted in the interior wall, floor, and roof of a building, integrated into building structures such as baseboard, skirting board, frieze, or crown molding, placed on or affixed to furniture such as table, desk, and bench; or positioned to places where wire connections for electric power, signal, and data transmission are applicable. The cross-section of the platform 15 can be shaped as a semi-circle, semi-ellipse, and polygonal. Other shapes are possible. In one embodiment, the module-bearing platform 10 is a U-shaped module-bearing platform when viewed through a cross section, as shown in FIG. 2. For illustrative purpose, the function module 20 in FIG. 2 is depicted in a detached position relative to the platform 15. The function module 20 can be handily attached to or detached from the platform 15 through a reversible locking member 17 such as a clasp, a pivot, a lock, or an adhesive member. The wire pathway thus enclosed by the function module 20 and the platform 15 are further partitioned by metal plates into the strong current wire tunnel 11, the weak current wire tunnel 12, and the wire duct 13. In one preferred embodiment, the weak current wire tunnel 12 is located between the strong current wire tunnel 11 and the wire duct 13; furthermore, the strong current wire tunnel contains the strong current conductive wire comprising a hot wire 18H, a ground wire 18D, and a neutral wire 18L, all affixed to the interior wall of the strong current wire tunnel 11; furthermore, in one embodiment, two weak current conductive wires 19 and two network cables 21 are affixed to the interior wall of the weak current wire tunnel 12. Network cable can also be fastened to the interior wall of the wire duct 13. As can be appreciated by those skilled in the art, the relative positions of the strong current wire tunnel 11, the weak current wire tunnel 12, and the wire duct 13 can vary in accordance with need and is not limited what is described in figures. In addition, the neutral wire 18D, the hot wire 18H, the ground wire 18L, two weak current conductive wires 19, and two network cable 21 may also be placed in other positions as dictated by needs. They can be affixed to the interior wall by fastening, adhesion, attachment, or other means, or placed without fixed attachment.

In one embodiment of the present invention, a layer of insulation material is placed on the, interior wall of the strong current wire tunnel 11. The protective layer minimizes the risk of electric shock to a user and enhances the safety of the system,

In one embodiment of the current invention, a metal layer is provided to cover the function module surface that faces the module-bearing platform 15. The function modules 20 can be standardized in uniform size and attached to the module-bearing platform 15 by ways of physical embedding, riveting, screwing, clasping, or adhesion, among other methods. Alternatively, the function modules 20 can be made into varying sizes and placed onto the module-beating platform 15. In some embodiments, the function modules 20 are permanently attached to the platform 15. In other embodiments, the function modules 20 can be added to or removed from the module-bearing platform 15 based on needs. When the attachment of the function modules to the module-bearing platform is detachable and reversible, one or more function modules can be easily secured into or removed from the platform, based on user's preference or application environment.

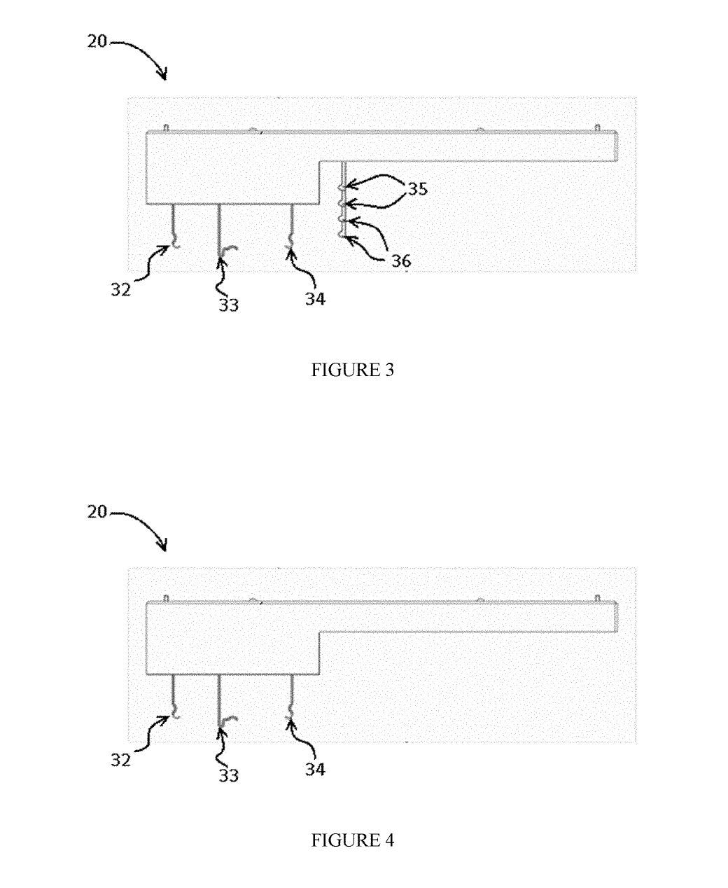

In one embodiment of the present invention, the strong current conductive wire is configured to be electrically coupleable to one or more function modules 20. The strong current conductive wire is also electrically coupleable to an external power source such as power mains, distribution mains, and a power line, thus the strong current conductive wire can provide the one or more function modules 20 with strong current electric power. In some embodiments all function modules 20 are configured to couple to an external power source; in other embodiments none of the function modules 20 are coupled to the external power source. As shown in FIG. 3, a function module 20 configured to be electrically interfaced with the external power source is provided with a hot wire contact interface 32, a ground wire interface 33, and a neutral wire interface 34, the latter three are operable to become electrically interfaced with the hot wire 18H, the ground wire 18D, and the neutral wire 18L, respectively. The electric coupling can be activated either by attaching the function module 20 to the platform 15, or through an on/off trigger such as a push button. In addition, one or more function modules 20 can communicate data with background server through the network cable 21 that links the one or more function modules to the background server.

In one embodiment, the plurality of the function modules 20 include at least one power source switching module, which can be connected to the strong current conductive wire and operable to convert strong current electric power into weak current electric power required for some other function modules 20. As shown in FIGS. 2 and 3, the power source switching module acquires strong current electric power though connections between the hot, wire contact interface 32 to hot wire 18H, the ground wire contact interface 33 to the ground wire 18D, and the neutral wire contact interface 34 to the neutral wire 18L, respectively. The power source switching module convert the strong current electric power, such as 110V, 60 Hz electricity, into weak current electric power, such as 5V or 20V direct current. The power source switching module has one or more weak current contact interface 35 that are configured electrically interface with the weak current conductive wire 19 located within the weak current wire tunnel 12, and can provide weak current electric power, such as 5V or 20 V direct current, to other function modules that are electrically coupled to the weak current conductive wire 19 through their own weak current contact interface 35.

Weak current refers to electric current of extra low voltage such as 5V or 20V. Weak currents are widely used to operate many electrical engineering systems in human habitation, including fire alarm detection system, audiovisual systems, building automation and building management system, master clock system, nurse call system, public address system, security systems, data networks systems, and telephone systems.

In one embodiment, one or more function modules 20 can be a wireless transceiver that transmit or receive wireless data. The wireless transceiver is connected with the background server via the network cable 21. Thus, if other function modules need to communicate with a wireless communication equipment, the wireless transceiver can fulfill the need by both communicating with the wireless communication equipment wirelessly and communicating with the other function modules through wire. In some embodiments, wireless transceiver can be WIFI wireless transceiver, Zigbee wireless transceiver, Z-Wave wireless transceiver, Bluetooth wireless transceiver, and infrared wireless transceiver such as infrared controller.

In one embodiment, one or more function modules 20 are data collection module, function execution module, or a combination thereof The data collection module transfers collected data to the background server via the network cable or 21, and the background server processes and analyzes the collected data. After processing and analyzing, instructions are sent, to the function execution module via the network cable 21 when needed. In another embodiment, a data collection module may be equipped with a data processer and perform initial analyses and processing before sending out the processed data to the background server via the network cable 21. In still another embodiment, a data collection module may be provided with a data processer, perform analyses and processing on collected data, and directly transmit via the network cable 21 commands or instructions to the function execution module, bypassing the background server. In yet another embodiment, the data collection model and the function execution model are integrated into one and same function module. Data collection module includes senor modules used in human habitations, such as light collection module, environmental data collection module, weather and climate data collection module, voice and phonics collection module, human behavior data collection module, and video data collection module, among others.

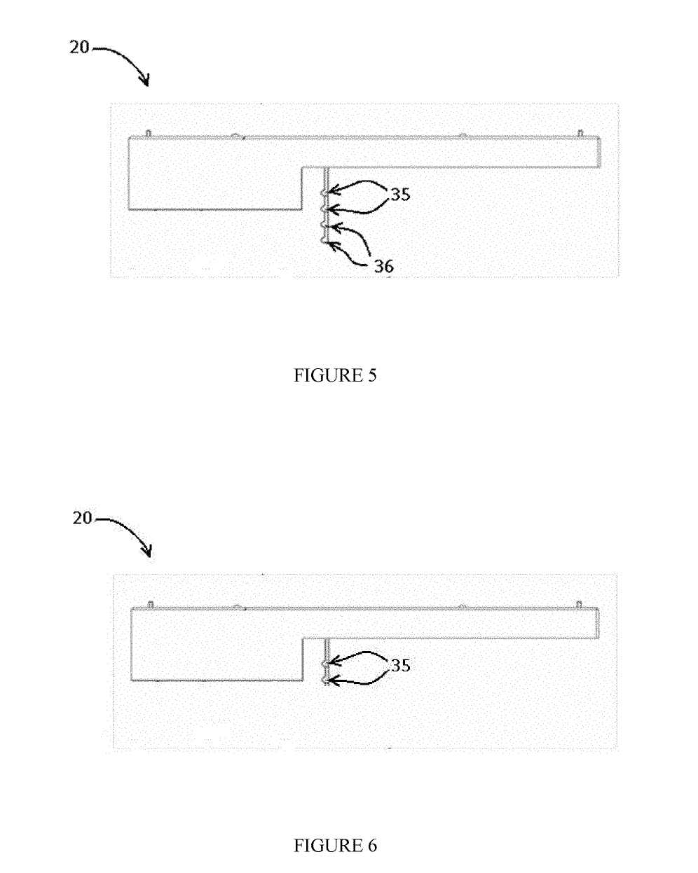

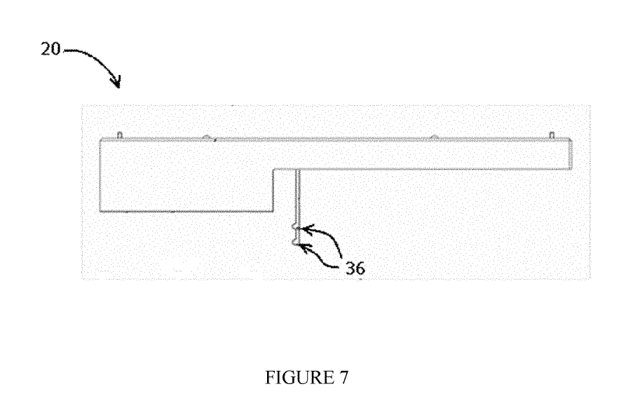

In one embodiment, function modules that vary both structurally and functionally are used. As shown in FIG. 4, one type of function module is limited to acquiring electric power from power lines, such as a socket or receptacle. This type of function module has the hot wire contact interface 32 configured to couple to the hot wire 18H, the ground wire contact interface 33 configured to couple to the ground wire 18D, and the neutral wire contact interface 34 configured to couple to the neutral wire 18L, respectively. As shown in FIG. 5, another type of function module is specialized for communicating with background servers. This type of function module has the weak current contact interface 35 configured to electrically link to the weak current conductive wire 19 in order to get weak current electric power. This type of function module also has the network cable interface 36 configured to link to a network cable 21 and transmits data to a background server. Examples of this type of function modules include gas sensors. As shown in FIG. 6, still another type of function module is a weak current electric power outlet, such as USB outlet, that has a weak current contact interface 35 configured to interface with weak current conductive wire 19 to conduct weak current electric power. As shown in FIG. 7, yet another type of function module has its own power source and network cable interface 36 that is configured to connect to the network cable 21. Examples of this type of function modules includes many data collection modules and execution modules. Other combinations, formats, and variations are possible.

Network cables are network hardware used to connect one network device to other network devices or to connect server or computers to each other or to a network device. In all embodiments of the present invention, industrial buses can be used in lieu of network cables. In some embodiments, different types of network cables, such as Ether net, coaxial cable, twisted pair cables, fiber optic cable and optical fiber cable can be used. Through the network cables 21, the function modules can communicate not only with the background server that hosts the central logic of a home system, but also among different modules themselves, providing enhanced design flexibility. Wireless communication can also be incorporated into the wired communication in the system. The function modules, interconnected in the system, can act in response to instructions sent, from the background server, based on modules' own logic, environmental cues, or status of other function modules. The communication can be stats, instructions and data. The protocol for communication on cables can be TCP/IP, UDP and any other types. The wireless communication protocol can be WIFI, Zigbee, and any other protocols.

As described, a wiring system is disclosed that includes a module-bearing platform 15 and a plurality of function modules 20 used in human habitation that are attached to the platform 15. The plurality of function modules is connected to weak current conductive wire 19 and a network cable 21 through physical wires, Such a configuration solves the instability problem prevalent in wireless communication of smart home system. The device disclosed in the present invention also has strong safety features when applied in human habitation and enhances compatibility. Finally, the device disclosed in the present invention has great scalability since various function modules can be added or removed easily based on user's needs.

A method is disclosed for efficiently providing access to strong current electric power, weak current electric power, and wired communicating network to a human habitation. The steps for the methods are: proving a module-bearing platform 15; attaching a plurality of function modules 20 to the platform 15, wherein the platform 15 and the plurality of the function modules 20 encloses a wire pathway that is further divided into a strong current wire tunnel 11 and a weak current wire tunnel 12; installing, within the strong current wire tunnel 11, a strong current conductive wire operable to be electrically coupled to a power line, wherein at least one of the function modules 20 is configured to be electrically linked to the strong current conductive wire; installing a weak current conductive wire 19 within the weak current wire tunnel 11, and providing a network cable 21 located within the wire duct 13 and, configured to connect to a background server.

In one embodiment, the method includes placing most of the weak current conductive wire 19 through the wire duct 13, reducing electro-magnetic interference caused by a large number of the weak current conductive wire 19. In one embodiment, the method further reduces interference by providing metal plates to separate the strong current wire tunnel 11 and the weak current wire tunnel 12, and applying a metal layer to surfaces of the function modules that face the platform 15. The function modules 20 can be reversibly secured to the module-bearing platform 15 by a method chosen from the group of physical embedding, riveting, screwing, clasping, and adhesion. Users can add a function module or remove one of the secured function modules based on need.

In one embodiment, a function module is provided that converts strong current, electric power to weak current electric power. Some of the plurality of the function modules 20 is connected to the weak current conductive wire 19 to acquire weak current electric power, Some of the plurality of the function modules is connected to the network cable 21 to transmit signal or instruction.

While the invention has been particularly shown and described as referenced to the embodiments thereof, those skilled in the art will understand that the foregoing and other changes in form and detail may be made therein without departing from the spirit and scope. The embodiments described above are preferred embodiments of the present invention, but the embodiments of the present invention are not limited to the above-described embodiments, and other changes, modifications, substitutions, combinations, abbreviations, and equivalents may be made without departing from the spirit and principle of the present invention, and are to be construed as equivalent permutations and are intended to be included within the scope of the present invention.

What is claimed is:

1. A physical wiring system, comprising:
a module-bearing platform;
a plurality of function modules removably attached onto the platform, wherein the platform and the plurality of the function modules enclose a wire pathway that is further divided into a strong current wire tunnel and a weak current wire tunnel;
a strong cumin conductive wire located within the strong current wire tunnel and operable to be electrically coupled to an external power source, wherein at least one of the function modules is configured to be electrically linked to the strong current conductive wire;
a weak current conductive wire located within the weak current wire tunnel; and
a network cable located within the weak current wire tunnel and configured to connect with a background server.

2. A physical wiring system according to claim 1, wherein the number and the function of the function modules attached on the module-bearing platform can be increased or decreased based on needs.

3. A physical wiring system according to claim 1, further comprising:
a wire duct located within the wire pathway enclosed by the platform and the plurality of the function modules, and configured to house the weak current conductive wire.

4. A physical wiring system according to claim 3, wherein the weak current conductive wire travels through the wire duct, and at least a portion of the network cable is located in the wire duct.

5. A physical wiring system according to claim 1, wherein at least one of the plurality of the function modules is connected to the weak current conductive wire.

6. A physical wiring system according to claim 1, further comprising:
a network cable configured to link to at least one of the plurality of the function modules.

7. A physical wiring system according to claim 1, wherein the platform is a U-shaped platform

8. A physical wiring system according to claim 7, wherein the U-shaped platform is made of metal.

9. A physical wiring system according to claim 8, further comprising:
one or more metallic plates that divide the wire pathway enclosed by the platform and the plurality of the function modules into the strong current wire tunnel, the weak current wire tunnel, and a wire duct.

10. A physical wiring system according to claim 9, wherein the weak current wire tunnel is located between the strong current wire tunnel and the wire duct, and further comprising:
a hot wire, and a ground wire, and a neutral wire, all comprised of the strong current conductive wire, wherein the hot wire, the ground wire and the neutral wire are affixed onto the interior walls of the strong current wire tunnel;
two weak current conductive wires affixed onto an interior wall of the weak current wire tunnel; and
two network cables affixed onto an interior wall of the wire duct.

11. A physical wiring system according to claim 1, further comprising:
a metal layer comprised of the attached function modules and located on the surface facing the platform.

12. A physical wiring system according to claim 1, wherein the function modules are attached to the platform through physical embedding, riveting, screwing, clasping, or adhesion.

13. A physical wiring system according to claim 1, wherein the network cable is one selected from the group of Ethernet cable and fiber optic cable.

14. A method for efficiently providing electric power and wired communicating network to a human habitation, comprising the steps of:
providing a module-bearing platform;
attaching a plurality of function modules to the platform, wherein the platform and the plurality of the function modules encloses a wire pathway that is further divided into a strong current wire tunnel, a weak current wire tunnel, and a wire duct;
installing, within the strong current wire tunnel, a strong current conductive wire configured to be electrically coupled to a power line, wherein at least one of the function modules is configured to be electrically linked to the strong current conductive wire;
installing a weak current conductive wire within the weak current wire tunnel; and
providing a network, cable located within the wire duct and configured to connect with a background server.

15. A method according to claim 14, further comprising the step of:
placing most of the weak current conductive wire through the wire duct.

16. A method according to claim 14, further comprising the step of:
connecting at least one of the plurality of the function modules to the weak current conductive wire.

17. A method according to claim 14, further comprising the step of:
connecting at least one of the plurality of the function modules to the network cable.

18. A method according to claim 14, further comprising the steps of:
removably securing the function modules to the module-bearing platform by a method chosen from the group of physical embedding, riveting, screwing, clasping, and adhesion; and
adding a function module or removing one of the secured function modules based on need.

19. A method according to claim 14, further comprising the steps of:
providing metal plates to separate the strong current wire tunnel and the weak current wire tunnel; and
applying a metal layer to surfaces of the plurality of the function modules that face the platform.

20. A method according to claim 14, further comprising the steps of:
providing a function module that converts strong current electric power to weak current electric power; and
conducting the converted weak current electric power to other attached function modules through the weak current conductive wire.
